(19) United States
(12) Patent Application Publication
(10) Pub. No.: US 2015/0336380 A1
(43) Pub. Date: Nov. 26, 2015

(54) METHOD FOR OPERATING A PRINTING PRESS

(71) Applicant: HEIDELBERGER DRUCKMASCHINEN AG, HEIDELBERG (DE)

(72) Inventor: NIKOLAUS PFEIFFER, HEIDELBERG (DE)

(21) Appl. No.: 14/719,370

(22) Filed: May 22, 2015

(30) Foreign Application Priority Data
May 22, 2014 (DE) 102014007852.3

(51) Int. Cl. B41F 33/10

(52) U.S. Cl. CPC B41F 33/10

(57) ABSTRACT

In a method for operating a printing press, when an interruption of a printing process occurs during a print job, an ink profile in an inking unit is at least partly reduced or evened out in a first step by interrupting a supply of ink and printing a defined number of sheets while the ink supply is interrupted and by having a cylinder carry out a defined number of revolutions in the process. In a second step the ink profile is completely built up again by resuming the supply of ink and carrying out a reintroduction of ink without printing on the same defined number of sheets while the cylinder carries out the same defined number of revolutions in the process.

### CROSS-REFERENCE TO RELATED APPLICATION

This application claims the priority, under 35 U.S.C. §119, of German Patent Application DE 10 2014 007 852.3, filed May 22, 2014; the prior application is herewith incorporated by reference in its entirety.

### BACKGROUND OF THE INVENTION

### Field of the Invention

The present invention relates to a method for operating a printing press.

When a print job is being processed, a printing press may be stopped for various reasons (such as washing a blanket, changing a sheet stack). During such interruptions, the ink profile on the rollers is evened out in an undesired way and the ink interacts with the air, i.e. it loses moisture. When the printing operation is restarted, that results in start-up waste, i.e. in sheets of poor quality that cannot be sold. Mechanical solutions to that problem, such as separating inking unit roller groups during the interruption or stopping the oscillating movement of the distributor rollers during the interruption, are applied to prevent the undesired evening out of the ink profile. Disadvantages of those solutions to the problem are that they are technically complex and cause the formation of rings in the inking unit, for instance when UV inks are used. In addition, evaporated moisture is not compensated for and the ink is not renewed.

German Patent DE 43 12 229 C2, corresponding to U.S. Pat. No. 5,447,102, discloses a method for obtaining a distribution of ink that is close to the distribution of ink during production printing when a job change is carried out. When a print job change is carried out, a printing plate of the previous print job is replaced by a printing plate of the following print job.

### SUMMARY OF THE INVENTION

It is accordingly an object of the invention to provide a method for operating a printing press, which overcomes the hereinafore-mentioned disadvantages of the heretofore-known methods of this general type.

With the foregoing and other objects in view there is provided, in accordance with the invention, a method for operating a printing press, which comprises, in the case of an interruption in an ongoing print job, carrying out a first step which is to at least partially reduce an ink profile in an inking unit by interrupting the supply of ink and printing a defined number of sheets while the supply of ink is interrupted, and by having a cylinder carry out a specific number of revolutions in the process, and carrying out a second step which is to completely reestablish the ink profile by resuming the supply of ink and by introducing ink without printing on the same specific number of sheets and having the cylinder carry out the same specific number of revolutions.

The cylinder is understood to be a forme cylinder, a blanket cylinder (offset cylinder), or preferably an impression cylinder of the printing unit to which the inking unit belongs, but not a roller of the inking unit or a potentially associated dampening unit.

The defined number of sheets may be 15, for instance. In this case, 15 sheets will be printed during the first step without any supply of ink from an ink fountain before the printing process is stopped, i.e. the blanket cylinder is thrown off or moved away from the impression cylinder.

The introduction of ink from the ink fountain in the second step is completed once the defined number of “virtual” sheets (15 in the given example) has been conveyed through the printing press. The virtual sheets are understood to be sheets that could have been conveyed due to the cylinder revolutions of one or more impression cylinders and of one or more transport cylinders if a sheet feeder had been active and had provided sheets to the cylinders while the ink was introduced, which was not the case, however.

The defined number of revolutions of the cylinder correlates with the defined number of sheets and is equal to the latter, for instance. Consequently, in the given example, the defined number of revolutions of the cylinder is 15. In a case in which the cylinder is an impression cylinder, the correlation between the conveying of the sheets to reduce the ink profile or the conveying of the virtual sheets (non-conveying of sheets) during the introduction of ink on one hand and the cylinder revolutions on the other hand is even clearer because the impression cylinder is known to be a cylinder for transporting sheets.

An advantage of the method of the invention is that it solves the problems described above and reduces start-up waste.

In accordance with a further development, the interruption of the printing process is a machine stop for color measurement or color control purposes while the printing press is being set up or a machine stop to clean a blanket or a machine stop due to defective sheets during production printing or a machine stop after an ok sheet has been achieved as the printing press is being set up before production printing is started or a machine stop due to a change of the sheet stack or an expected printing break.

When the printing press is set up before the production run is started, print quality parameters such as the application of ink are measured on the sheets and settings are corrected based on the results of the measurement; for instance, the metering device on the ink fountain is readjusted. In order to avoid waste, it may be expedient to temporarily interrupt the printing process during the measurement and/or during the readjustment.

In the course of a print job, intermediate cleaning operations on the blanket may need to be carried out, for instance when a large amount of paper dust from the sheets has accumulated thereon. These intermediate cleaning operations may be carried out on a regular basis or as needed. During an ongoing production run, defective sheets may occur and be detected. Such defective sheets may be caused, for instance, by problems in the dampening unit. In order to eliminate the problem, the printing process needs to be interrupted, causing the printing press to be stopped.

When the printing press is set up for a print job, some defective sheets cannot be avoided for it takes some time until a sheet of acceptable quality is printed. This sheet is known as an ok sheet. Once the ok sheet has been obtained, further set-up operations may be necessary before the production run starts. Such set-up operations require the printing process to be interrupted between the ok sheet and the production run.

A large print job may require the feeder of the printing press to be provided with a fresh supply of unprinted, empty sheets and printed sheets to be removed from the sheet delivery to make room for following sheets. The stack changes that are required for this purpose may be carried out during non-stop operation or during an interruption of the printing process. Only the latter of the two cases requires an interruption of the printing process and is therefore relevant in the context of the method of the invention.

The processing of a print job may take more than one work shift. In terms of their timing, such a change of shift that takes place in the meantime or rest periods are foreseeable or plannable interruptions of the printing process. In contrast, an emergency stop is an unforeseeable interruption of the printing process and cannot be planned. The interruption of the printing process to which the method of the invention refers is an interruption of the printing process that is not an emergency stop.

In accordance with a further development, the movement of a roller is stopped during the first step to interrupt the supply of ink.

The roller in question may be an ink fountain roller or a vibrator roller. A vibrator roller periodically oscillates back and forth between the ink fountain roller and an inking unit roller, preferably a distributor roller, to transfer the ink from the former to the latter. In this process, the vibrator roller alternatingly enters into rolling contact with the ink fountain roller and with the inking unit roller. If the roller to be stopped to interrupt the supply of ink is a vibrator roller, the oscillating movement thereof is stopped. If the roller to be stopped is an ink fountain roller, the rotary movement thereof is stopped.

In accordance with a further development, in the first step, all ink zones of a metering device are closed to interrupt the supply of ink. The metering device is disposed on the ink fountain and includes metering elements that are disposed in a row parallel to the ink fountain roller and may be embodied as metering cams, metering slides, metering tabs, or metering levers. One metering element is provided for every ink zone. Adjusting the respective metering element towards the ink fountain roller causes a metering gap formed therebetween to be closed, preventing the ink fountain roller from conveying ink out of the ink fountain through the gap in question. In order to interrupt the supply of ink in the first step, the metering gaps are completely closed in all ink zones that are present.

In accordance with a further development, one or more distributor rollers continue to carry out their reciprocating lateral movement without interruption while the printing process is being interrupted. The single distributor roller or every distributor roller carries out the reciprocating movement along the axis of rotation of the roller both in the first step and in the second step of the method of the invention. A device such as a clutch coupling for stopping the reciprocating movement for the time of the interruption of the printing process may be dispensed with, reducing the manufacturing costs of the printing press.

In accordance with a further development, the defined number of sheets that is printed in the first step is used as acceptable sheets. Although these sheets were printed while no ink was being supplied from the ink fountain, their quality is sufficient for them to be used; they do not qualify as waste that needs to be disposed of.

In accordance with a further development, one and the same printing forme or printing plate is used in the printing process before and after the interruption of the printing process. No plate change is carried out while the printing process is being interrupted. Accordingly, the interruption of the printing process is not an interruption of the printing process between two different print jobs.

Other features which are considered as characteristic for the invention are set forth in the appended claims.

Although the invention is illustrated and described herein as embodied in a method for operating a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a vertical-sectional view of parts of a printing press;

FIG. 2 is a production flow chart for the printing press shown in FIG. 1; and

FIG. 3 is a diagram of an ink profile in an inking unit of the printing press shown in FIG. 1.

### DETAILED DESCRIPTION OF THE INVENTION

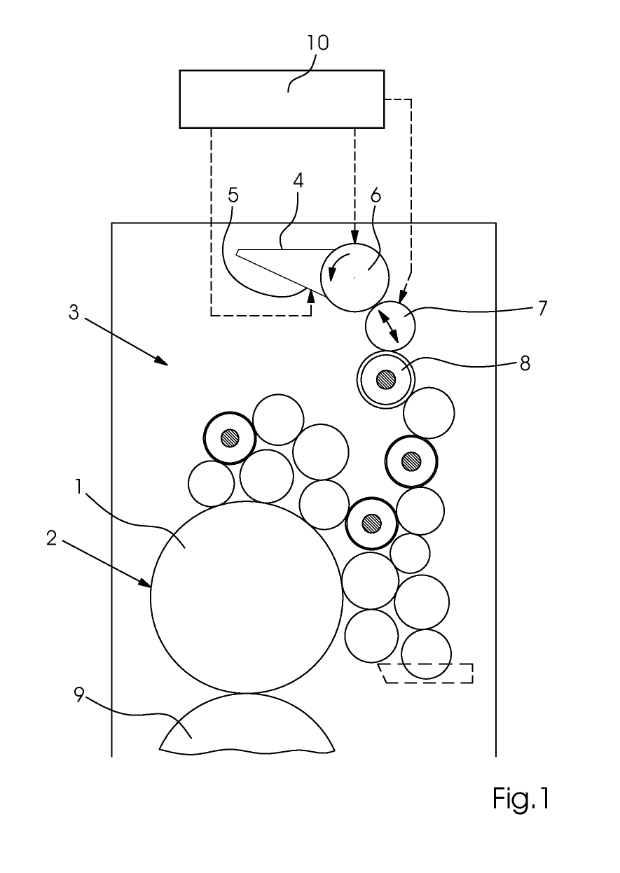

Referring now to the figures of the drawings in detail and first, particularly, to FIG. 1 thereof, there is seen an illustration of a section of a printing press for printing on sheets. The illustrated section represents parts of a printing unit for planographic offset printing. A forme cylinder 1 carries a printing plate 2 to which ink is supplied by an inking unit 3. The inking unit 3 includes an ink fountain 4 with a metering device 5 and an ink fountain roller 6. A vibrator roller 7 oscillates back and forth between the ink fountain roller 6 and a distributor roller 8. The ink is transmitted from the forme cylinder 1 to a blanket cylinder 9 and from blanket cylinder 9 to the sheets. The ink zone openings of the metering device 5, the rotary movement of ink fountain roller 6, and the oscillating movement of vibrator roller 7 are controlled by a control unit 10 in accordance with the programming thereof.

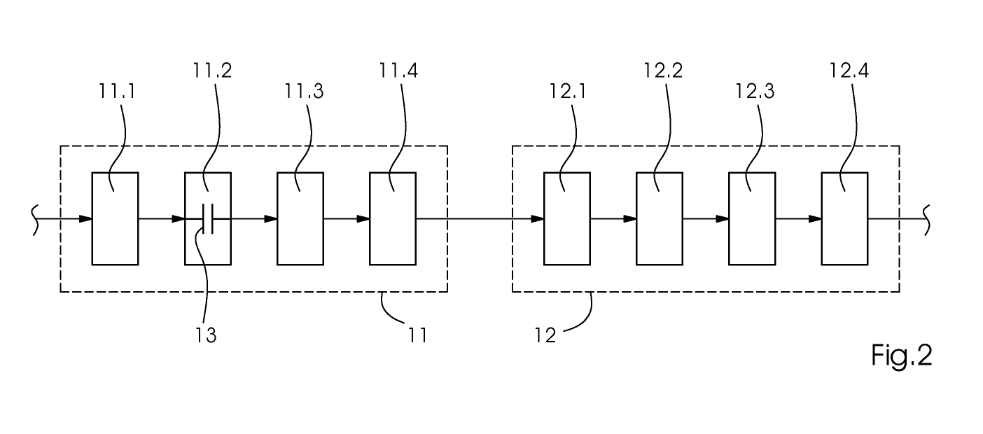

FIG. 2 is a work flow chart. At the beginning, the printing press processes a first print job 11, then a second print job 12. A first job step 11.1, 12.1 for each print job is to mount the printing plate 2 to the forme cylinder 1. A second step 11.2, 12.2 of each print job is to set up the inking unit 3, and a third step 11.3, 12.3 is a production run. A fourth job step 11.4, 12.4 is to dismount the printing plate 2 from the forme cylinder 1. In terms of its print image, the printing plate 2 that is mounted and dismounted in job steps 11.1, 11.4 of the first print job is a different printing plate 2 than the one that is mounted and dismounted in job steps 12.1, 12.4 of the second print job 12.

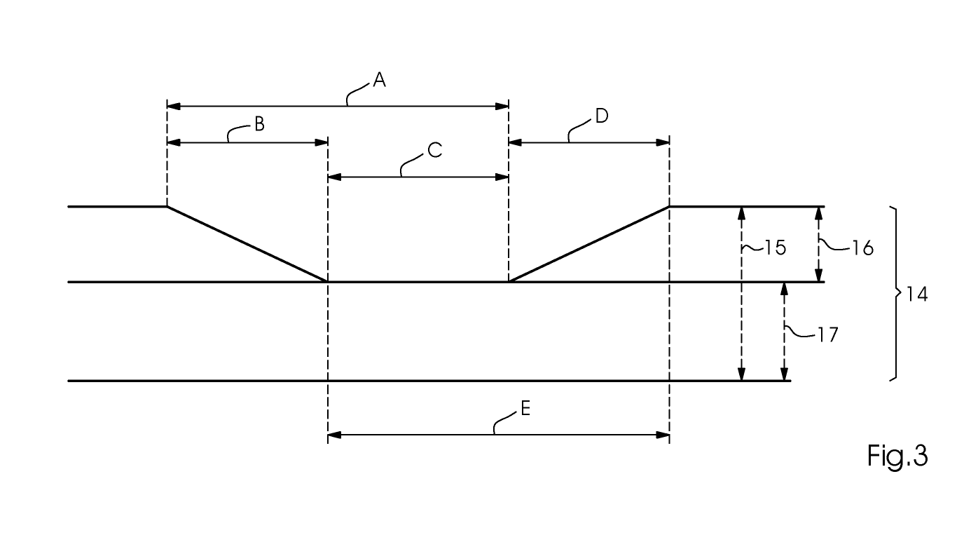

When the inking unit 3 is being set up in the second job step 11.2 of the first print job 11, an interruption 13 of the printing process involving an interruption of the sheet transport of the printing press during a period E (see FIG. 3) will regularly or foreseeably occur.

The control unit 10 controls the inking unit 3 in such a way that during a period A (see FIG. 3) of the interruption 13 of the printing process, no ink is transferred from the ink fountain 4 to the distributor roller 8, with the control unit 10 programmed to implement one of the following three options:

In accordance with the first option, the control unit 10 actuates the metering device 5 in such a way that its metering elements in all of the ink zones are moved so close to the ink fountain roller 6 that the during period A, the rotating ink fountain roller 6 does not convey any ink out of any ink zone of ink fountain 4. This means that in every ink zone, the ink zone setting is set to “zero”. The control unit 10 controls the actuating motors of the metering elements in a corresponding way.

In accordance with the second option, the control unit 10 actuates the ink fountain roller 6 in such a way that the latter no longer rotates. Due to the rotary standstill of the ink fountain roller 6, during the period A of the interruption 13 of the print job ink fountain roller 6 does not convey any ink out of ink fountain 4. For this purpose, the control unit 10 actuates a motor of the ink fountain roller 6 or a coupling clutch connecting the ink fountain roller 6 to the motor in accordance with the program that runs on control unit 10.

In accordance with the third option, the control unit 10 controls the vibrator roller 7 in such a way that it no longer carries out an oscillating movement. During the period A of the interruption 13 of the printing process, the vibrator roller 7 may be in rolling contact exclusively with the ink fountain roller 6 (and not with the distributor roller 8) or in rolling contact exclusively with the distributor roller 8 (but not with the ink fountain roller 6) or not in contact with any one of the two rollers 6, 8. For this purpose, the control unit 10 actuates a motor of the vibrator roller 7 or a coupling clutch connecting the vibrator roller 7 to the motor in accordance with the program that runs on control unit 10.

In all three options, the program on the control unit 10 envisages that an interruption 13 of the printing process automatically triggers an interruption of the supply of ink from the ink fountain 4 to the distributor roller 8 and that the interruption of the supply of ink continues during the entire period A. A termination of the interruption 13 of the printing process (start of the printing operation) automatically causes ink to be introduced from the ink fountain 4 to the rest of the inking unit 3. The start of the printing operation is initiated by an operator pushing a button. The reintroduction of ink occurs in a period of time D (see FIG. 3), during which the ink fountain roller 6 rotates, the vibrator roller 7 oscillates, and not all of the metering elements of the metering device 5 are set to the “zero” ink zone setting. While ink is being reintroduced, the metering elements may be set to a zonal metering profile (ink introduction metering profile) that differs from a zonal metering profile (production run metering profile) to which the metering elements are set during the production run once the introduction of ink has been completed. The ink introduction metering profile may be an inverted version of the production run metering profile, i.e. for the ink introduction metering profile, those metering elements that are opened farther for the production run metering profile are farther closed and those metering elements that are closed farther for the production run metering profile are farther opened. The ink introduction metering profile is used for a faster establishment of a stable inking condition that is suitable for the image to be printed and corresponds to the production run metering profile.

The vibrator roller 7 is supported for rotation in a lever that is supported to pivot in a joint. During a printing operation and during the period D (see FIG. 3) of the interruption 13 of the printing process, the motor of the vibrator roller 7 drives the lever through a cam mechanism to cause the lever to pivot back and forth about the joint to cause the vibrator roller 7 to oscillate.

FIG. 3 illustrates an ink film thickness/time diagram of the ink film thickness of an ink profile 14 in the inking unit 3. The period A is formed of a period B and a period C and is initiated automatically or by an operator who pushes a button. For the entire period A, the supply of ink is interrupted in accordance with one of the three options explained above. For the period B, the sheets continue to be transported by the transport cylinders and the impression cylinders from a sheet feeder to a sheet delivery and through the illustrated printing unit. During this process, the sheets are printed in the printing unit and therefore the amount of ink present in the inking unit region between the vibrator roller 7 and the forme cylinder 1 is reduced because no ink is supplied from the ink fountain 4.

In the period B, the ink profile 14 present in this inking unit region is reduced from a total ink film thickness 15 to a basic ink film thickness 17 by a build-up ink film thickness 16. The basic ink film thickness 17 is independent of the area coverage to be printed and is the same on all rollers of the inking unit region. The build-up ink film thickness 16 is determined by the production printing metering profile of the metering device 5 as described above and depends on the area coverage to be printed in the various ink zones and is not the same on all of the rollers: within the roller train, the build-up ink film thickness 16 declines from the distributor roller 8 to the ink applicator rollers due to the ink splitting effect. For this reason, the build-up ink film thickness 16 is also referred to as an ink wedge.

The sheets that are printed in the period B, which amount to 14 sheets (if the vibrator roller 7 carries out one oscillation for every two revolutions of the forme cylinder 1) or 15 sheets (if the vibrator roller carries out one oscillation for every three revolutions of the forme cylinder 1), are of acceptable quality and are not removed as waste sheets from the sheet stack in the sheet delivery or before they are delivered onto the delivery stack. In the period C, the build-up ink film thickness 16 in the inking unit region is completely evened out as a result of the printing of the 14 or 15 sheets, leaving only the basic ink film thickness 17 therein. In the period C, no sheets are transported in the printing press and the work to be done in the context of the interruption 13 of the printing process, for instance the color measurement or the color control operation, is carried out by the operator.

In the period C, the rollers of the inking unit region including the distributor roller 8 rotate to keep the rheological properties of the thixotropic ink present in the inking unit region constant due to the ink splitting effect. Since the reintroduction of ink occurs in a period D, the reciprocating axial movement of the distributor roller 8 (and of further distributor rollers in inking unit 3) need not be stopped during the period C. Measures used to stop the reciprocating movement such as coupling clutches that would otherwise be necessary may thus be dispensed with, reducing the manufacturing cost of the printing press. The build-up ink film 16, which is evened out during the period B by the printing of the 14 or 15 sheets without ink supply and which is rebuilt up due to the reintroduction of ink in the period D, is the measure for an image-based ink distribution in the ink zones, i.e. the zonal ink distribution. For reasons explained above, in the method of the invention, the zonal ink distribution does not risk being evened out by the axial reciprocating movement of the distributor roller(s).

A period E is formed of the period C and the following period D. In the aforementioned period E, no sheets are transported through the printing press and the printing unit. The transport cylinders and the impression cylinders of the printing press rotate during the period D yet without transporting any sheets. The period D lasts over precisely the number of cylinder revolutions of the forme cylinder 1, of the blanket cylinder 9, of the transport cylinders and of the impression cylinder as in the period B. Nevertheless, the periods B and D may differ in terms of their duration, for instance if the revolutions per minute or speeds of the cylinders are different. At the end of the period D, which also constitutes the end of the period E, the build-up ink film 16 has been completely reestablished due to the introduction of ink and the program restarts the transport of sheets and the printing operation. From this point on, the sheets are printed again in the printing unit.

1. A method for operating a printing press, the method comprising the following steps:
upon a printing interruption during a print job:
in a first step, at least partially reducing an ink profile in an inking unit by interrupting a supply of ink and printing a defined number of sheets while the ink supply is interrupted and by having a cylinder carry out a defined number of revolutions; and
in a second step, completely building up the ink profile again by resuming the supply of ink and carrying out a reintroduction of ink without printing on the same defined number of sheets while the cylinder carries out the same defined number of revolutions.

2. The method according to claim 1, wherein the printing interruption is not an emergency stop.

3. The method according to claim 1, wherein the printing interruption is one of:
a machine stop for color measurement or color control purposes while the printing press is being set up,
a machine stop to wash a blanket,
a machine stop due to defective sheets in a production run,
a machine stop once an OK sheet has been achieved while the printing press is being set up and before the production run starts,
a machine stop to carry out a sheet stack change, or
a foreseeable printing break.

4. The method according to claim 1, which further comprises stopping a movement of a roller in the first step to interrupt the supply of ink.

5. The method according to claim 4, wherein the roller is an ink fountain roller.

6. The method according to claim 4, wherein the roller is a vibrator roller.

7. The method according to claim 1, which further comprises closing all ink zones of a metering device in the first step to interrupt the supply of ink.

8. The method according to claim 1, which further comprises reciprocating one or more distributor rollers in an axial direction during the printing interruption.

9. The method according to claim 1, which further comprises using the defined number of sheets being printed in the first step as acceptable sheets.

10. The method according to claim 1, which further comprises using one and the same printing plate for printing before and after the printing interruption.
